(19) United States
(12) Patent Application Publication
(10) Pub. No.: US 2022/0212427 A1
(43) Pub. Date: Jul. 7, 2022

(54) UV CURING APPARATUS FOR CONTACT-LENS POLYMERIZATION PROCESS

(71) Applicant: HOPE VISION CO., LTD., Miaoli County (TW)

(72) Inventors: SHIH HONG CHU, TAICHUNG CITY (TW); ZHENG JUN SU, HSINCHU COUNTY (TW); CHENG TAI JAO, TOUFEN CITY (TW); HSIN PEI YU, MIAOLI COUNTY (TW); HUAN CHIU TSEN, HSINCHU CITY (TW)

(21) Appl. No.: 17/204,177

(22) Filed: Mar. 17, 2021

(30) Foreign Application Priority Data
Jan. 7, 2021 (TW) 110100600

(51) Int. Cl. B29D 11/00; B29C 35/08

(52) U.S. Cl. CPC B29D 11/00134; B29C 2035/0827; B29C 35/0805; B29D 11/0048

(57) ABSTRACT

A UV (ultraviolet) curing apparatus for a contact-lens polymerization process is provided. A UV curing module is equipped for the mold cavities of contact-lens curing molds, including a plurality of first UV light sources arranged above the mold cavities and a plurality of second UV light sources arranged below the mold cavities. A plurality of first light output areas of a first light guide device guides the light beams emitted by the first UV light sources to illuminate upper light receiving surfaces of the molds. A plurality of second light output areas of a second light guide device guides the light beams emitted by the second UV light sources to illuminate lower light receiving surfaces of the molds. Thereby, the contact-lens polymer inside the molds is uniformly cured, and the yield is raised.

This application claims priority of Application No. 110100600 filed in Taiwan on 7 Jan. 2021 under 35 U.S.C. § 119; the entire contents of all of which are hereby incorporated by reference.

### BACKGROUND OF THE INVENTION

### Field of the Invention

The present invention relates to a contact-lens fabrication apparatus, particularly to a UV (ultraviolet) curing apparatus for a contact-lens polymerization process.

### Description of the Prior Art

The contact lenses can replace ordinary eyeglasses to overcome problems of vision. Therefore, the contact lens is a popular option for the persons suffering from visual degradation, such as myopia. The contact lens with a colored annularity around the optical area has become an essential fashion accessory in many countries and thus assumes the position of fashion statement. Some types of contact lenses not only can correct vision but also can present a special style of the users.

The fabrication process of contact lenses includes steps of machining, casting, spin-coating, thermal curing/UV curing, etc. Refer to FIG. 1. In the conventional technology of fabricating contact lenses, a conveyor 50 is used to convey a receiving disc 52 carrying a plurality of molds 51; a contact-lens polymer 53 is injected into the molds 51; a plurality of strip-like UV tube lamps 54 is used to illuminate the contact-lens polymer 53, whereby to cure the contact-lens polymer 53; after the molds 51 are split, contact lenses are obtained. In the conventional technology, the UV light is only projected to a single surface of the molds until the whole contact-lens polymer is completely cured, which leads to poor curing effect, different curing extents in different regions of the contact-lens polymer, and poor production efficiency. Further, the uneven curing of the contact-lens polymer is likely to cause instability of the optical region, distorted structure, and cracks, which may seriously affect the yield.

### SUMMARY OF THE INVENTION

The primary objective of the present invention is to provide a UV (ultraviolet) curing apparatus for a contact-lens polymerization process, wherein different portions of a UV curing module are respectively arranged above and below mold cavities, and wherein light guide devices are used to let the upper and lower light receiving surfaces of the molds be fully illuminated by the curing light, whereby the contact-lens polymer inside the molds are cured uniformly, and whereby is shortened the curing time, promoted the yield and decreased the fabrication cost.

In order to achieve the abovementioned objective, the present invention provides a UV curing apparatus for a contact-lens polymerization process. The UV curing apparatus of the present invention comprises a carrying device, a UV curing module, a first light guide device and a second light guide device. The carrying device includes a plurality of mold cavities. The plurality of mold cavities respectively carries molds. The mold receives a contact-lens polymer. The mold has an upper light receiving surface and a lower light receiving surface. The upper light receiving surface is a planar surface, and the lower light receiving surface is a curved surface. The UV curing module includes a plurality of first UV light sources and a plurality of second light UV light sources. The first UV light sources are arranged above the mold cavities. The second UV light sources are arranged below the mold cavities. The first light guide device includes a plurality of first light output areas. The first light output areas are respectively corresponding to the first UV light sources and disposed between the first UV light sources and the mold cavities, whereby the first light guide device guides the light beams emitted by the first UV light sources to pass through the corresponding first light output areas and illuminate the corresponding upper light receiving surfaces of the molds. The second light guide device includes a plurality of second light output areas. The second light output areas are respectively corresponding to the second UV light sources and disposed between the second UV light sources and the mold cavities, whereby the second light guide device guides the light beams emitted by the second UV light sources to pass through the corresponding second light output areas and illuminate the corresponding lower light receiving surfaces of the molds.

According to one embodiment of the present invention, the first light guide device includes a first substrate. A plurality of first light guide holes is formed on the first substrate to function as the first light output areas. The first light guide device constrains the light beams emitted by the first UV light sources to transmit inside the first light guide holes.

According to one embodiment of the present invention, the diameter of each of the first light guide holes is gradually decreased from the position near the first UV light sources to the position far away from the first UV light sources.

According to one embodiment of the present invention, the first substrate includes a delustering material. In one embodiment, the first substrate is made of a plastic material. Preferably, the first substrate is made of a glass or metallic material coated with a delustering film.

According to one embodiment of the present invention, the second light guide device includes a second substrate. A plurality of second light guide holes is formed on the second substrate to function as the second light output areas. The second light guide guide constrains the light beams emitted by the second UV light sources to transmit inside the second light guide holes.

According to one embodiment of the present invention, the diameter each of of the second light guide holes is gradually decreased from the position near the second UV light sources to the position far away from the second UV light sources.

According to one embodiment of the present invention, the second substrate includes a delustering material. In one embodiment, the second substrate is made of a plastic material. Preferably, the second substrate is made of a glass or metallic material coated with a delustering film.

According to one embodiment of the present invention, the first light guide device includes a plurality of light-focusing lenses, which form the plurality of first light output areas. The first light guide device passes the light beams emitted by the first UV light sources through the light-focusing lenses and then vertically projects onto the upper light receiving surface of the mold.

Below, embodiments are described in detail to make easily understood the objectives, characteristics and accomplishments of the present invention.

### BRIEF DESCRIPTION OF THE DRAWINGS

FIG. 1 shows a conventional UV curing apparatus for contact-lenses.

FIG. 2 is a sectional view schematically showing a UV curing apparatus for a contact-lens polymerization process according to a first embodiment of the present invention.

FIG. 3 is a sectional view schematically showing a UV curing apparatus for a contact-lens polymerization process according to a second embodiment of the present invention.

FIG. 4 is a sectional view schematically showing a UV curing apparatus for a contact-lens polymerization process according to a third embodiment of the present invention.

FIG. 5 is a sectional view schematically showing a UV curing apparatus for a contact-lens polymerization process according to a fourth embodiment of the present invention.

### DETAILED DESCRIPTION OF THE INVENTION

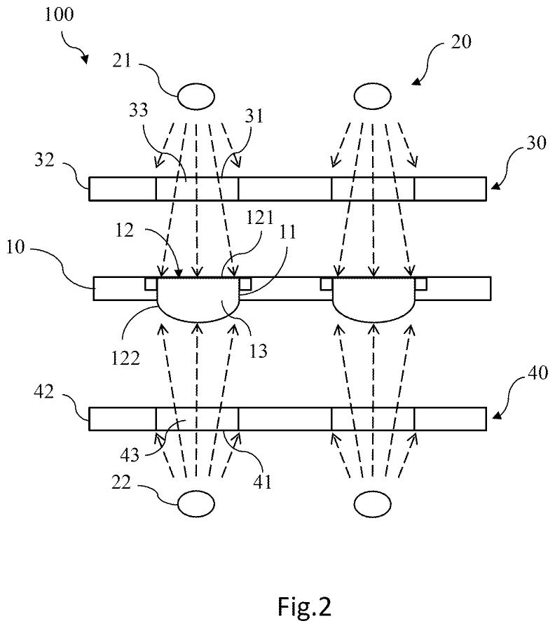

Refer to FIG. 2. FIG. 2 is a sectional view schematically showing a UV (ultraviolet) curing apparatus 100 for a contact-lens polymerization process according to a first embodiment of the present invention. In this embodiment, the UV curing apparatus 100 comprises a carrying device 10, a UV curing module 20, a first light guide device 30 and a second light guide device 40. A plurality of mold cavities 11 is intermittently disposed in the carrying device 10. The mold cavity 11 is a space used to carry a mold 12. The mold 12 is made of a light-permeable material, such as a PP plastic, allowing the UV ray to pass. The mold 12 includes an upper light receiving surface 121 and a lower light receiving surface 122 opposite to the upper light receiving surface 121. The upper light receiving surface 121 is a planar surface. The lower light receiving surface 122 is a curved surface. A contact-lens polymer 13 is disposed inside the mold 12. It is well known by the persons skilled in the art: the contact-lens polymer 13 is a material, which can be polymerized to form a contact lens. The contact-lens polymer 13 may be a hydrophilic monomer (such as Poly (2-hydroxyethyl methacrylate)), a hydrophobic monomer (such as siloxane) or a monomer mixture thereof. The contact-lens polymer 13 may further include another material or component having a special function, such as a photoinitiator, a thermal initiator, or an additive for increasing the hydrophilicity of the contact lens.

The UV curing module 20 includes a plurality of first UV light sources 21 and a plurality of second UV light sources 22. The first UV light sources 21 are arranged above the mold cavities 11 and the second UV light sources 22 are arranged below the mold cavities 11 such that the upper region and the lower region of each mold cavity 11 are substantially corresponding to one first UV light source 21 and one second UV light source 22 respectively. In this embodiment, the first UV light sources 21 and the second UV light sources 22 are light-emitting diodes. Each light-emitting diode is a point light source where brightness is concentrated.

The first light guide device 30 includes a plurality of first light output areas 31. Each first light output area 31 is corresponding to one first UV light source 21 and disposed between the first UV light source 21 and the mold cavity 11, whereby to guide the light beam emitted by the first UV light source 21 to pass through the corresponding first light output area 31 and illuminate the upper half of the mold cavity 11, i.e. illuminate the upper light receiving surface 121 of the mold 12. In this embodiment, the first light guide device 30 includes an opaque first substrate 32 and a plurality of first light guide holes 33. The first light guide holes 33 form the plurality of first light output areas 31. The first light guide hole 33 constrains the light beam emitted by the corresponding first UV light source 21 to transmit inside the first light guide hole 33, whereby the light is concentrated to illuminate the upper light receiving surface 121, and whereby the upper light receiving surface 121 is exempted from being interfered with by neighboring light sources.

The second light guide device 40 includes a plurality of second light output areas 41. Each second light output area 41 is corresponding to one second UV light source 22 and disposed between the second UV light source 22 and the mold cavity 11, whereby to guide the light beam emitted by the second UV light source 22 to pass through the corresponding second light output area 41 and illuminate the lower half of the mold cavity 11, i.e. illuminate the lower light receiving surface 122 of the mold 12. In this embodiment, the second light guide device 40 includes an opaque second substrate 42 and a plurality of second light guide holes 43. The second light guide holes 43 form the plurality of second light output areas 41. The second light guide hole 43 constrains the light beam emitted by the corresponding second UV light source 22 to transmit inside the second light guide hole 43, whereby the light is concentrated to illuminate the lower light receiving surface 122, and whereby the lower light receiving surface 121 is exempted from being interfered with by neighboring light sources.

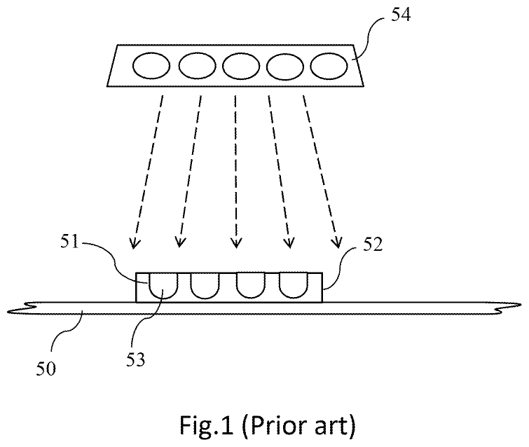

In one embodiment, the first substrate 32 and the second substrate 42 may include a delustering material, which can decrease the refraction while the light passes through the light guide hole 33 or the second light guide hole 43. In one embodiment, the substrate 32 is made of a plastic material. In another embodiment, the substrate 32 or the second substrate 42 is made of a glass or metallic material coated with a delustering film. In one embodiment, the carrying device 10 is a transport mechanism (such as the conveyor 50 in FIG. 1), which moves in an inching way to transport each mold cavity 11 to a position between one first UV light source 21 and one second UV light source 22, whereby the mold 12 carried by each mold cavity 11 is arranged corresponding to the first UV light source 21 and the second UV light source 22, and whereby the contact-lens polymer 13 inside the mold 12 is cured by the illumination of UV light. After cooling down, the mold 12 is split to obtain a contact lens. Via the first light guide device 30 and the second light guide device 40, the present invention makes the light beams of the first UV light source 21 and the second UV light source 22 able to effectively illuminate the whole mold cavity 11. Thereby, the upper light receiving surface 121 and the lower light receiving surface 122 are fully illuminated, and the contact-lens polymer 13 inside the mold 12 is uniformly cured. Thus, the present invention can shorten the curing time, promote the yield and decrease the fabrication cost.

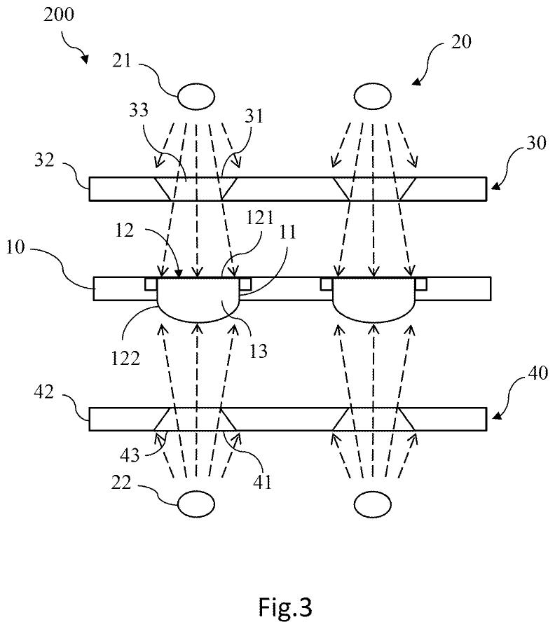

In the abovementioned embodiments, the diameters of the first light guide hole 33 and the second light guide hole 43 are slightly greater than the light source and designed to be a cylindrical-shaped hole. However, the present invention does not limit the shape and size of the first light guide hole 33 and the second light guide hole 43 but allows the shape and size to be modified according to practical requirement. Refer to FIG. 3. FIG. 3 is a sectional view schematically showing a UV curing apparatus 200 for a contact-lens polymerization process according to a second embodiment of the present invention. The second embodiment is different from the first embodiment in that the diameter of the first light guide hole 33 is gradually decreased from the position near the first UV light source 21 to the position far away from the first UV light source 21. In other words, the first light guide hole 33 is a conical-shaped hole in the second embodiment. Similarly, the diameter of the second light guide hole 43 is designed to be gradually decreased from the position near the second UV light source 22 to the position far away from the second UV light source 22. In other words, the second light guide hole 43 is a conical-shaped hole in the second embodiment. Therefore, the present invention can make light uniformly illuminate the mold 12 via decreasing the divergence angles of the light beams projecting from the first light guide hole 33 and the second light guide hole 43.

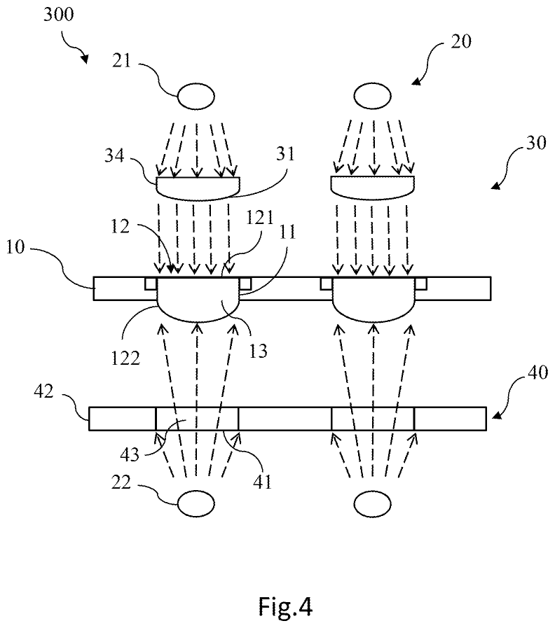

Refer to FIG. 4. FIG. 4 is a sectional view schematically showing a UV curing apparatus 300 for a contact-lens polymerization process according to a third embodiment of the present invention. The third embodiment is different from the first embodiment and the second embodiment in that the first light guide device 30 includes a plurality of light-focusing lenses 34, which form the plurality of light output areas 31. The light-focusing lenses 34 can make the light beams passing through them vertically project onto the upper halves of the mold cavities 11, i.e. vertically project onto the upper light receiving surfaces 121 of the molds 12. In one embodiment, the light-focusing lens 34 is a Fresnel lens. In the third embodiment, the light-focusing lenses 34 are used to modify the illumination paths of the curing light sources and improve the problem of light scattering, whereby the planar light receiving surfaces 121 of the molds 12 can be more uniformly illuminated.

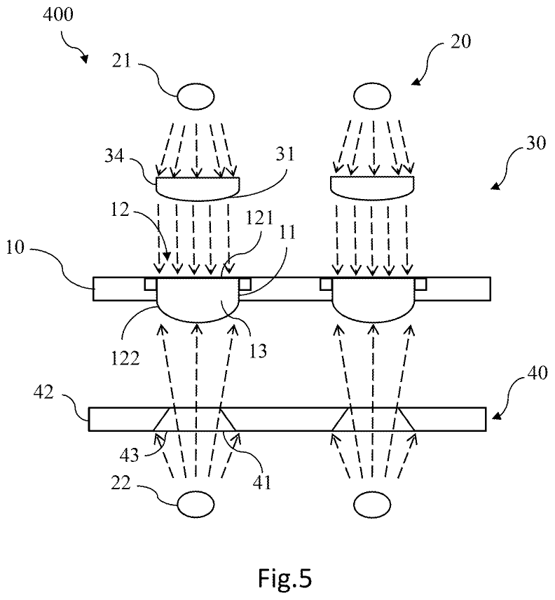

Refer to FIG. 5. FIG. 5 is a sectional view schematically showing a UV curing apparatus 400 for a contact-lens polymerization process according to a fourth embodiment of the present invention. The fourth embodiment is different from the third embodiment in that the diameter of the second light guide hole 43 is designed to be gradually decreased from the position near the second UV light source 22 to the position far away from the second UV light source 22. In other words, the second light guide hole 43 is a conical-shaped hole. Thereby, the lower light receiving surfaces 122 of the molds 12 are illuminated more uniformly via decreasing the divergence angles of the light beams projecting from the second light guide hole 43.

The embodiments described above are only to exemplify the present invention but not to limit the scope of the present invention. Any equivalent modification or variation according to the spirit or characteristics of the present invention is to be also included by the scope of the present invention.

What is claimed is:

1. A UV curing apparatus for a contact-lens polymerization process, comprising
a carrying device, including a plurality of mold cavities, wherein the plurality of mold cavities respectively carries molds; the mold receives a contact-lens polymer; the mold has an upper light receiving surface and a lower light receiving surface; the upper light receiving surface is a planar surface, and the lower light receiving surface is a curved surface;
a UV (ultraviolet) curing module, including a plurality of first UV light sources and a plurality of second light UV light sources, wherein the first UV light sources are arranged above the mold cavities; the second UV light sources are arranged below the mold cavities;
a first light guide device, including a plurality of first light output areas, wherein each of the first light output areas is corresponding to one of the first UV light sources and disposed between the first UV light sources and the mold cavities, and wherein the first light guide device guides the light beams emitted by the first UV light sources to pass through the first light output areas, which are respectively corresponding to the first UV light sources, and illuminate the upper light receiving surfaces of the molds; and
a second light guide device, including a plurality of second light output areas, wherein each of the second light output areas is corresponding to one of the second UV light sources and disposed between the second UV light sources and the mold cavities, and wherein the second light guide device guides the light beams emitted by the second UV light sources to pass through the second light output areas, which are respectively corresponding to the second UV light sources, and illuminate the lower light receiving surfaces of the molds.

2. The UV curing apparatus for a contact-lens polymerization process according to claim 1, wherein the first light guide device includes a first substrate; a plurality of first light guide holes is formed on the substrate to function as the first light output areas; the first light guide device constrains the light beams emitted by the first UV light sources to transmit inside the first light guide holes.

3. The UV curing apparatus for a contact-lens polymerization process according to claim 2, wherein a diameter of each of the first light guide holes is gradually decreased from a position near the first UV light sources to a position far away from the first UV light sources.

4. The UV curing apparatus for a contact-lens polymerization process according to claim 2, wherein the first substrate includes a delustering material.

5. The UV curing apparatus for a contact-lens polymerization process according to claim 4, wherein the first substrate is made of a plastic material.

6. The UV curing apparatus for a contact-lens polymerization process according to claim 4, wherein the first substrate is made of a glass or metallic material coated with a delustering film.

7. The UV curing apparatus for a contact-lens polymerization process according to claim 1, wherein the second light guide device includes a second substrate; a plurality of second light guide holes is formed on the second substrate to function as the second light output areas; the second light guide device constrains the light beams emitted by the second UV light sources to transmit inside the second light guide holes.

8. The UV curing apparatus for a contact-lens polymerization process according to claim 7, wherein a diameter of each of the second light guide holes is gradually decreased from a position near the second UV light sources to a position far away from the second UV light sources.

9. The UV curing apparatus for a contact-lens polymerization process according to claim 7, wherein the second substrate includes a delustering material.

10. The UV curing apparatus for a contact-lens polymerization process according to claim 9, wherein the second substrate is made of a plastic material.

11. The UV curing apparatus for a contact-lens polymerization process according to claim 9, wherein the second substrate is made of a glass or metallic material coated with a delustering film.

12. The UV curing apparatus for a contact-lens polymerization process according to claim 1, wherein the first light guide device includes a plurality of light-focusing lenses, which form the plurality of first light output areas; the first light guide device passes the light beams emitted by the first UV light sources through the light-focusing lenses and then vertically projects onto the upper light receiving surface of the mold.
